(19) United States
(12) Patent Application Publication
(10) Pub. No.: US 2024/0292859 A1
(43) Pub. Date: Sep. 5, 2024

(54) Reverse Water Migration Glaze for Baked Goods

(71) Applicant: Del-Val Food Ingredients, Moorestown, NJ (US)

(72) Inventors: Rick Cavanaugh, Oak Ridge, NC (US); Chuck Galliher, Cherry Hill, NJ (US); Anthony Garcia, Clemmons, NC (US)

(21) Appl. No.: 18/592,724

(22) Filed: Mar. 1, 2024

Related U.S. Application Data
(60) Provisional application No. 63/488,050, filed on Mar. 2, 2023.

(51) Int. Cl. A23G 3/34; A23G 3/42; A23G 3/48

(52) U.S. Cl. CPC A23G 3/343; A23G 3/42; A23G 3/48

(57) ABSTRACT

The present invention relates to a glaze or icing, specifically, a glaze comprising a sugar system comprising a first non-crystalline fully saturated phase, a second water-based phase, and a third crystalline phase for application to baked goods. The invention also relates to methods of making the glaze/icing and applying it to baked goods this glaze, as well as the baked goods themselves which are coated with the glaze.

### CROSS-REFERENCE TO RELATED APPLICATIONS

This application claims priority to U.S. Provisional Application No. 63/488,050, filed Mar. 2, 2023, which is incorporated by reference in its entirety.

### FIELD OF THE INVENTION

This invention relates to bakery glazes and icings. More specifically, the invention relates to a superior stable glaze on a pre-packaged, shelf-stable baked good that allows a limited amount of moisture to move from the stable glaze/icing to the cake/dough portion, thereby creating a finished baked good with increased moistness, better taste, and higher consumer appeal than those that are currently marketed. This invention further relates to methods for making this glaze, as well as the baked goods themselves that are coated with the glaze.

### BACKGROUND OF THE INVENTION

All baked goods are perceived as superior when the cake/dough portion of the baked good contains relatively high moisture. In sealed packages, moisture content will transfer between doughs, fillings, icings, glaze and even packaging, causing one to dry, and the other to increase in moisture or melt, which limits the shelf-life and perceived quality of the baked good. Consumers typically find baked goods that are drier to be less desirable than more moist baked goods. Moisture loss or moisture transfer is a major contributor the loss of palatability in baked goods. It has been the goal of the baked food industry to increase shelf life of the baked goods to increase consumption by the consumer and increase the range of shipping without the use of refrigeration or freezing.

Furthermore, all foods degrade to some degree after packaging, including baked goods. Having a food increase in palatability over time is unheard of in packaged food shelf life. Increasing the palatability of food after packaging has major cost savings in shipping and marketing of the food. Frozen transport is expensive. Food waste at store level and consumer level is a significant hidden cost caused by food drying and staling.

All baked good food companies have strived to increase the stability of baked food glazes to increase the amount of time to sell and to consume the finished product. Placing high water activity baked goods with glazes and icings in a package has been considered impossible in the art without drying of the cake/dough portion and melting of the glaze portion.

Consumers desire packaged bakery products with a sweet water-based glaze that is stable. Packaging baked goods allows for increasing the range of distribution, thereby enabling the consumer to purchase and consume the product over many weeks at their convenience. Typically, baked goods will degrade over time. Staling, drying, and moisture migration are major contributors of this degradation. Solving the drying and moisture migration issues will allow for higher quality packaged shelf-life baked goods.

Formulating water glazes and icings in baked goods has posed challenges in the art. The ratio of super saturated sugar solution to the crystalline sugar significantly impacts the nature of a glaze and, thus, the glaze's stability.

Industry standard bakery water glazes are commonly used on donuts, danishes, cakes, cinnamon rolls, and other bakery items. These standard water glazes are typically a mixture of 50-75% powdered sucrose, 12-28% granulated sucrose, 12-28% water, and 0.1-1% agar or other gums, emulsifiers, and fats. In these standard glazes, the water activity is very low, and the glazes will pull water from the cake, donut or dough portion in a closed package. This pulling of water lowers the moisture content of the dough or cake portion, while causing the glaze to melt and to become wet and sticky. This process causes a significant degradation of the perceived quality and shelf life of the baked good. In a sealed package, the entire package will hit equilibrium with the moisture going from points of high water activity to points of low water activity or dough/cake to the glaze. For example, a common packaged baked item are enrobed cake mini donuts. These are cake mini donuts enrobed in a chocolate compound coating that is fat based. In such donuts, dehydrated cocoa particles are suspended in a fat-based coating. The moisture migrates from the cake donut to the cocoa particles in the enrobed coating, causing the donut to dry significantly over 7-14 days. Typical shelf life of packaged, enrobed cake mini donuts, for example, is about 45-60 days. Water-based icings have not been accepted by the consumer in chocolate enrobed cake donuts due to the chocolate icing melting due to moisture transfer from the donut, resulting in a wet messy chocolate topping.

Persons of skill in the art of formulating baked goods have expended much effort to make a glaze with the perfect ratio of the amount of sugar, as well as the types and amounts of gums in the glaze, with no success in maintaining perfect glaze stability without degradation of the cake/dough portion. For example, U.S. Pat. No. 9,943,085, claims a fondant that comprising a sugar system made up of a first non-crystalline phase and a second crystalline phase, wherein the non-crystalline phase contains isomaltulose and sucrose and wherein the crystalline phase contains isomaltulose (herein referred to as “Beneo's fondant”). The natural flow of water in Beneo's fondant is from the cake/dough to the glaze, which breaks down the glaze. Beneo's U.S. Pat. No. 9,943,085, column 6, lines 48-50 states: “Advantageously, a coating resulting from the fondant according to the invention will absorb little to no water at all from the interior of the coated product and the ambient air”. Therefore, the goal of the inventors of Beneo's fondant was to minimize or stop this flow of water from the cake or dough to the fondant.

Therefore, an unmet need in the art of making baked goods is to reverse this moisture flow between the dough/cake and the glaze, such that the dough/cake does not dry out, and the glaze stays dry. Such a drier glaze is beneficial, as it does not melt and/or stick to the packaging and is more attractive and desirable for the consumer.

### SUMMARY OF THE INVENTION

In one embodiment, the present invention provides a glaze comprising a sugar system comprising: a first non-crystalline fully saturated phase; a second water-based phase; and a third crystalline phase, wherein: the first non-crystalline fully saturated phase comprises: one primary sugar chosen from: isomaltulose and trehalose; water; and at least one hydrocolloid gum; the second water-based phase comprises: at least one ingredient chosen from: cocoa; a hydrocolloid gum; and a food grade fiber; and a food grade starch; and the third crystalline phase comprises: at least one sugar chosen from: isomaltulose and trehalose suspended in the mixture of the first non-crystalline phase and the second water-based phase.

In another embodiment, the present invention provides a glaze that comprises at least one hydrocolloid gum in both the first non-crystalline phase and the second water-based phase is chosen from: guar gum; xanthan gum; gellan; carboxymethyl cellulose (CMC), pectin; gelatin; Alginate; Carrageenan; Cassia; Fenugreek; Gum Arabic; Gum Ghatti; Gum Karaya; Konjac; locust bean gum; and tara.

In yet another embodiment, the at least one food grade fiber in the second water-based phase of the glaze is chosen from: potato; banana; wheat; sugar cane; sugar pea; lentil; chia; pear; apple; orange; almond; broccoli; peanut; rice; cellulose. In another embodiment, the at least one food grade starch in the glaze is chosen from: corn, tapioca, potato, and banana.

In an additional embodiment, the first, fully saturated non-crystalline phrase further comprises about 0.01-5% of at least one ingredient chosen from: a flavoring; a salt; a fat; an artificial sweetener; a preservative; an emulsifier; a pH modifier; a coloring; and a preservative.

In a further embodiment, either or both of the first non-crystalline, fully saturated phase and the third crystalline further comprises at least one secondary sugar chosen from: isomaltulose; trehalose; sucrose; dextrose; fructose; glucose; and allulose. Preferably, in either or both of the first non-crystalline, fully saturated phase and the third crystalline phrase, the at least one secondary sugar is sucrose.

In yet another embodiment, the ratio of the first non-crystalline fully saturated phase 1 and second water-based phase to the third crystalline phase of the glaze is 1.3:1 to 2:1.

In yet another embodiment, the present invention provides a method for making a glaze to coat a baked good comprising the steps of:
a. mixing a combination of: about 20-55% water; about 20-60% of one primary sugar chosen from: isomaltulose and trehalose; and at least one ingredient chosen from: about 3-30% cocoa; about 0.2-5% of at least one hydrocolloid gum; about 0.5-5% of at least one food grade fiber; and about 0.5-10% of at least one food grade starch; and
b. heating the mixture from step a. to about 170° F.-218° F. for about 0.5 seconds-30 minutes;
c. adding the hot syrup from step b. into about 35-65% of a sugar chosen from of: isomaltulose and trehalose, which results in the glaze;
d. holding the glaze made in step c. at from about 115-160° F.; and
e. applying the glaze from step d. to the baked good at from about 115-160° F.

In a further embodiment of this method, the hydrocolloid gum from step a. is chosen from: agar; guar gum; xanthan gum; glean; gellan; carboxymethyl cellulose (CMC), pectin; gelatin; Alginate; Carrageenan; Cassia; Fenugreek; Gum Arabic; Gum Ghatti; Gum Karaya; Konjac; locust; bean gum; and tara. In another embodiment, at least one food grade fiber in the second water-based phase is chosen from: potato; banana; wheat; sugar cane; sugar pea; lentil; chia; pear; apple; orange; almond; broccoli; peanut; rice; cellulose; and the at least one food starch in the second phase is chosen from: corn; tapioca; potato; and banana. In a further embodiment, the glaze in this method further comprises about 0.01-5% of at least one ingredient chosen from: a flavoring; a salt; a fat; an artificial sweetener; a preservative; an emulsifier; a pH modifier; a coloring; and a preservative.

In another embodiment of this method, step c. further comprises up to 40% of at least one secondary sugar chosen from: isomaltulose; trehalose; sucrose; dextrose; fructose; glucose; and allulose. Preferably, the at least one secondary sugar added in step c. of this method is sucrose. In an additional embodiment of this method, the baked good is chosen from: a donut; a cake; a pastry; a danish; and a cinnamon roll.

In another embodiment, the present invention provides a glaze made by the above-described method which comprises: about 20-60% of at least one primary sugar chosen from: isomaltulose; trehalose; sucrose; dextrose; fructose; glucose; and allulose; about 20-55% water; and at least one ingredient chosen from: about 3-30% cocoa; about 0.2-10% of at least one hydrocolloid gum; and about 0.5-5% of at least one food grade fiber; and about 0.5-10% of at least one food grade starch. In another embodiment, the glaze made by this method further comprises about 0.01-5% of at least one ingredient chosen from: a flavoring; a salt; a fat; an artificial sweetener; a preservative; an emulsifier; a pH modifier; a coloring; and a preservative. In yet another embodiment, this invention includes a baked good that is coated with the glaze made by the above-described method. These baked goods may be pre-packaged and shelf-stable.

In yet another embodiment, the above-described glaze further comprises about 0.01-5% of at least one ingredient chosen from: a flavoring; a salt; a fat; an artificial sweetener; a preservative; an emulsifier; a pH modifier; a coloring; and a preservative. In a further embodiment, this glaze further comprises up to 40% at least one secondary sugar chosen from: isomaltulose; trehalose; sucrose; dextrose; fructose; glucose; and allulose. Preferably, the at least one secondary sugar in the glaze is sucrose.

### DETAILED DESCRIPTION OF THE INVENTION

In the context of the present invention, the percentile proportions of the individual components indicated for a composition of components add up to 100%, i.e., the total composition, unless stated and/or obviously otherwise.

Within the context of the present invention, the term, “glaze” means a thin, glossy, sugar-based coating that is applied to a baked good to improve the baked good's taste and appearance. Such a glaze is typically flavored, for instance, with be flavored with cocoa, vanilla, or any other kinds of flavoring. The term, “glaze”, as used herein, is also to be interpreted to be synonymous with the term, “icing”.

Within the context of the present invention, the term “sugar system” is understood to be a mixture of at least two different sugars. Further, within the context of the present invention, the phrase “sugar system comprising a crystalline phase and a non-crystalline phase” refers, to a mixture of at least two sugars, wherein one of the sugars is at least partially crystalline and at least one of the other sugars is at least partially—particularly primarily or entirely—non-crystalline, and is present particularly as a syrup, solution, or especially a saturated solution.

As discussed above in the background section, the natural flow of water in Beneo's fondant is from the cake/dough to the glaze, which breaks down the glaze. Therefore, an unmet need in the art is a baked that has a cake/dough portion that stays moist when packaged and stored over a prolonged period, preferably for over 10 days.

Surprisingly, the present invention reverses this natural flow of water between the glaze and the cake/dough portion of the glaze. Specifically, in the present invention, water flows from the glaze to the cake/dough, which increases the moistness and palatability of the product. The present invention addresses the problem in the art, because the resultant glaze of the present invention still stays dry while the glaze improves the cake/dough portion of the baked good by maintaining a moister cake/dough while packaged. The present invention addresses the above-described problems in the prior art by providing a glaze having high storage stability and low hygroscopicity after use, which is particularly suitable for use as a less gooey, preferably glossy, transparent foodstuff coating or as a filling. The present invention encompasses a packaged baked good that has a moister cake/dough portion than any other similar packaged baked goods, resulting in a baked good that is more desirable to the consumer from both visual and taste perspectives.

The present invention creates a glaze that has three phases that do not degrade the glaze, but rather will donate water to the cake/dough portion making is moister than if not glazed. These three phases are: a first-non-crystalline fully saturated phase (“Phase 1”); a second water-based phase (“Phase 2”); and a third crystalline phase (“Phase 3”). By contrast, Beneo's fondant comprises two phases: (1) a sugar system comprising a first non-crystalline phase; and (2) a second crystalline phase.

Phase 1 of the present invention is made with one primary sugar chosen from: isomaltulose and trehalose; at least one hydrocolloid gum; water; and other ingredients. Phase 1 does not accept water from the dough or cake portion of the baked good. Because it is made with a high percentage of sugar that does not dissolve easily in water, the glaze provided by the present invention is stable and does not break down or melt, even with the high moisture content of Phase 2.

Phase 2 of the present invention is a substance that readily accepts and absorbs water and does not have a low water activity, such that it can donate its excess water to the cake/dough portion. Ingredients such as cocoa, fiber, or a starch-based ingredient could increase the water content of the icing while maintaining viscosity. This donated water is available to transfer from the glaze to the cake or dough portion of a baked good, allowing a controlled increase of moisture of the cake. The level of the water-binding ingredient will vary with its thickening power.

Phase 3 of the present invention, the crystalline phase, comprises one primary crystalline sugar chosen from: isomaltulose and trehalose suspended in the mixture of Phases 1 and 2. Phase 3 constitutes the largest percentage of the glaze. The majority of Phase 3 is isomaltulose or trehalose. There may also be at least one secondary sugar in Phase 3 that would dissolve will then become part of Phase 1. As the glaze cools, part of Phase 1 will crystallize and become part of Phase 3.

The ratio of Phases 1 and 2 to Phase 3 is 1.3:1 to 2:1.

Phase 1 and 3 of the glaze must contain either isomaltulose or trehalose, but can also contain one or more of the above-listed secondary sugars. Preferably, that additional, optional secondary sugar would be sucrose. However, the glaze could be made with just one of the two primary sugars. Sucrose helps making the glaze a bit sweeter, though, and sucrose helps to lower the water activity in the syrup phase. Without the sucrose, there would still be reverse moisture flow, but not as long a shelf-life due to the higher water activity.

The above-described donation of water from the glaze to the cake/dough portion in Phase 2 of the present invention cannot be achieved by currently marketed glazes, as the high water ingredients in Phase 2, specifically, at least one ingredient chosen from: cocoa; a hydrocolloid gum; and a food grade fiber; and a food grade starch, will melt a standard glaze/icing. Since Phase 1 of the present invention is made with a high percentage of sugar that does not dissolve easily in water, the resulting glaze that is stable and does not break down or melt, even with the high moisture content of Phase 2. The high water content of Phase 2 will not dissolve Phase 3, as isomaltulose and trehalose have very low solubility in water.

Surprisingly, baked goods coated with the glaze of the present invention yield a dry glaze with a cake or dough portion that has more moisture at day 7 after being packaged as compared to day 1. The cake/dough portion of packaged baked goods currently available on the market, by contrast, will be considerably drier at day 7 as compared to day 1 and continue to dry out during the shelf-life.

The present invention achieves a glaze that is stable in both frozen and ambient storage conditions. Equilibrium will not occur in the freezer. Once the product is thawed, the above-described equilibrium process will begin. Controlling the moisture migration, so that the moisture flows from the glaze/icing to the cake or dough portion solves two major issues in standard glazes. Specifically, the glaze of the present invention transfers moisture to the cake/dough. Therefore, the cake/dough does not lose moisture as the glaze/icing is contributing excess moisture to it.

The stable glaze of the present invention will be dry and will not stick to the packaging or a person's hands when being consumed. In addition, the dough/cake portion of the product will not lose moisture to the environment or to the glaze/icing. Baked products are considered by most to be more desirable when they are fresh. Baked goods are perceived as fresh when they are moist and soft, such that no portion has degraded by drying out or melting. The present invention presents a significant advance in the art by allowing the dough/cake portion to actually increase in moistness and softness as compared to the fresh baked product. The present invention creates a glaze that is perfectly stable with no melting of the glaze, while the dough/cake portion increases in moistness after several days in an airtight waterproof package, such as plastic clam shells or plastic flow wrapping.

To summarize, the three phases of the present invention, Phase 1 maintains and controls water activity. Phase 2 provides excess moisture to donate to the cake/dough, and Phase 3 makes the glaze/icing a solid.

In one embodiment, the present invention provides a glaze comprising a sugar system comprising: a first non-crystalline fully saturated phase; a second water-based phase; and a third crystalline phase, wherein: the first non-crystalline fully saturated phase comprises: one primary sugar chosen from: isomaltulose and trehalose; water; and at least one hydrocolloid gum; a second water-based phase comprises: at least one ingredient chosen from: cocoa; a hydrocolloid gum; and a food grade fiber; and a food grade starch; and the third crystalline phase comprises: at one primary sugar chosen from: isomaltulose and trehalose suspended in the mixture of the first non-crystalline phase and the second water-based phase.

In another embodiment, the present invention provides a glaze that comprises at least one hydrocolloid gum in both the first non-crystalline phase and the second water-based phase is chosen from: guar gum; xanthan gum; gellan; carboxymethyl cellulose (CMC), pectin; gelatin; Alginate; Carrageenan; Cassia; Fenugreek; Gum Arabic; Gum Ghatti; Gum Karaya; Konjac; locust bean gum; and tara.

In yet another embodiment, the at least one food grade fiber in the second water-based phase of the glaze is chosen from: potato; banana; wheat; sugar cane; sugar pea; lentil; chia; pear; apple; orange; almond; broccoli; peanut; rice; cellulose. In another embodiment, the at least one food grade starch in the glaze is chosen from: corn, tapioca, potato, and banana.

In an additional embodiment, the first, fully saturated non-crystalline phrase further comprises about 0.01-5% of at least one ingredient chosen from: a flavoring; a salt; a fat; an artificial sweetener; a preservative; an emulsifier; a pH modifier; a coloring; and a preservative.

In a further embodiment, either or both of the first non-crystalline, fully saturated phase and the third crystalline further comprises at least one secondary sugar chosen from: isomaltulose; trehalose; sucrose; dextrose; fructose; glucose; and allulose. Preferably, in either or both of the first non-crystalline, fully saturated phase and the third crystalline phrase, the at least one secondary sugar is sucrose.

In yet another embodiment, the ratio of the first non-crystalline fully saturated phase 1 and second water-based phase to the third crystalline phase of the glaze is 1.3:1 to 2:1.

In yet another embodiment, the present invention provides a method for making a glaze to coat a baked good comprising the steps of:
a. mixing a combination of: about 20-55% water; about 20-60% of one primary sugar chosen from: isomaltulose and trehalose; and at least one ingredient chosen from: about 3-30% cocoa; about 0.2-5% of at least one hydrocolloid gum; about 0.5-5% of at least one food grade fiber; and about 0.5-10% of at least one food grade starch; and
b. heating the mixture from step a. to about 170° F.-218° F. for about 0.5 seconds-30 minutes;
c. adding the hot syrup from step b. into about 35-65% of a sugar chosen from of: isomaltulose and trehalose, which results in the glaze;
d. holding the glaze made in step c. at from about 115-160° F.; and
e. applying the glaze from step d. to the baked good at from about 115-160° F.

In a further embodiment of this method, the hydrocolloid gum from step a. is chosen from: agar; guar gum; xanthan gum; glean; gellan; carboxymethyl cellulose (CMC), pectin; gelatin; Alginate; Carrageenan; Cassia; Fenugreek; Gum Arabic; Gum Ghatti; Gum Karaya; Konjac; locust; bean gum; and tara. In another embodiment, at least one food grade fiber in the second water-based phase is chosen from: potato; banana; wheat; sugar cane; sugar pea; lentil; chia; pear; apple; orange; almond; broccoli; peanut; rice; cellulose; and the at least one food starch in the second phase is chosen from: corn; tapioca; potato; and banana. In a further embodiment, the glaze in this method further comprises about 0.01-5% of at least one ingredient chosen from: a flavoring; a salt; a fat; an artificial sweetener; a preservative; an emulsifier; a pH modifier; a coloring; and a preservative.

In another embodiment of this method, step c. further comprises up to 40% of at least one secondary sugar chosen from: isomaltulose; trehalose; sucrose; dextrose; fructose; glucose; and allulose. Preferably, the at least one secondary sugar added in step c. of this method is sucrose. In an additional embodiment of this method, the baked good is chosen from: a donut; a cake; a pastry; a danish; and a cinnamon roll.

In another embodiment, the present invention provides a glaze made by the above-described method which comprises: about 20-60% of one primary sugar chosen from: isomaltulose; trehalose; sucrose; dextrose; fructose; glucose; and allulose; about 20-55% water; and at least one ingredient chosen from: about 3-30% cocoa; about 0.2-5% of at least one hydrocolloid gum; and about 0.5-5% of at least one food grade fiber; and about 0.5-10% of at least one food grade starch. In another embodiment, the glaze made by this method further comprises about 0.01-5% of at least one ingredient chosen from: a flavoring; a salt; a fat; an artificial sweetener; a preservative; an emulsifier; a pH modifier; a coloring; and a preservative. In yet another embodiment, this invention includes a baked good that is coated with the glaze made by the above-described method. These baked goods may be pre-packaged and shelf-stable.

In yet another embodiment, the above-described glaze further comprises about 0.01-5% of at least one ingredient chosen from: a flavoring; a salt; a fat; an artificial sweetener; a preservative; an emulsifier; a pH modifier; a coloring; and a preservative. In a further embodiment, this glaze further comprises up to 40% at least one secondary sugar chosen from: isomaltulose; trehalose; sucrose; dextrose; fructose; glucose; and allulose. Preferably, the at least one secondary sugar in the glaze is sucrose.

One method of making the glaze of the present invention is described below in Example 1. In addition, Example 2 describes the ingredients in six different glaze formulations.

### EXAMPLES

The present invention is further explained in the following examples, which are non-limiting.

### Example 1: Production Method for a Glaze According to the Invention

A solution containing Phases 1 and 2 can be made by:

### Boiling a Mixture of:

| | |
|---|---|
| 35-60% | Water |
| .05-1% | Agar or other gelling gum |
| 10-30% | Sucrose |
| 10-50% | Isomaltulose or trehalose |
| 10-50% | Fiber, cocoa starch |

### Optional Ingredients:

| | |
|---|---|
| 0-1% | High intensity sweeteners |
| 0-5% | Fats |
| 0-5% | Emulsifiers |
| 0-1% | Salt |
| 0-1% | pH modifiers |
| 0-2% | Flavors |
| 0-4% | Colors |
| 0-0.5% | Preservatives |

This mixture is boiled to fully hydrate the gums and starches, as well as to dissolve the sucrose and isomaltulose or trehalose to make a supersaturated solution.

The boiling Phase 1 and Phase 2 mixture is then mixed into powdered isomaltulose or trehalose in several stages to prevent lumping.

The ratio of Phase 1/Phase 2 to isomaltulose/trehalose is 1.3 to 2.0 parts of Phase 1/Phase 2 mixture to 1 part powder isomaltulose or trehalose.

This glaze/icing must be held and applied at 110-160° F. to keep the supersaturated solution from crystalizing too early. The liquid supersaturated portion keeps the glaze flowing allowing for a smooth application of the glaze or icing.

This glaze can be applied to cool or hot baked goods. Application on a cool baked good will result in a thicker glaze/icing as the Phase 1 portion will cool rapidly, setting the glaze more quickly before it can flow off of the baked good.

Once applied to the baked good, the baked good and glaze will cool, and a portion of the sugars will crystalize in the supersaturated portion of Phase 1, which will increase the viscosity to the point of setting. The agar or other gelling gum will also form a gel matrix to provide additional setting and drying.

Once the baked good with this glaze is packaged the contents will then start to reach equilibrium. In a sealed package, the water will migrate to areas of high water activity to areas of low water activity, including all of the contents of the package, as well as the packaging materials themselves. In this environment, Phase 2 will have the highest amount of available water to donate, and the baked good will accept this excess water, as the baking process has driven the water out of the surface.

The time to reach equilibrium will vary from approximately 1-7 days.

### Example 2: Formulations

Formulation 1: Chocolate Example

| | |
|---|---|
| Isomaltulose | 44% |
| Water | 28% |
| Sucrose | 20% |
| Cocoa | 8% |
| Sucralose | .2% |
| Citric Acid | .1% |
| Potassium Sorbate | .1% |
| Sorbic Acid | .2% |
| Agar | .05% |

Formulation 2: Fructose example

| | |
|---|---|
| Isomaltulose | 44% |
| Water | 28% |
| Fructose | 20% |
| Cocoa | 8% |
| Sucralose | .2% |
| Citric Acid | .1% |
| Potassium Sorbate | .1% |
| Sorbic Acid | .2% |
| Agar | .05% |

Formulation 3: Dextrose example

| | |
|---|---|
| Isomaltulose | 44% |
| Water | 28% |
| Dextrose | 20% |
| Cocoa | 8% |
| Sucralose | .2% |
| Citric Acid | .2% |
| Potassium Sorbate | .1% |
| Sorbic Acid | .1% |
| Agar | .05% |

Formulation 4: Xanthan gum example

| | |
|---|---|
| Isomaltulose | 44% |
| Water | 28% |
| Sucrose | 20% |
| Xanthan gum | 2% |
| Sucralose | .2% |
| Citric Acid | .2% |
| Potassium Sorbate | .1% |
| Sorbic Acid | .1% |
| Agar | .05% |

Formulation 5: Guar gum example

| | |
|---|---|
| Isomaltulose | 44% |
| Water | 28% |
| Sucrose | 20% |
| Guar gum | 4% |
| Sucralose | .2% |
| Citric Acid | .2% |
| Potassium Sorbate | .1% |
| Sorbic Acid | .1% |
| Agar | .05% |

Formulation 6: Starch example

| | |
|---|---|
| Isomaltulose | 44% |
| Water | 28% |
| Sucrose | 20% |
| Starch | 6% |
| Sucralose | .2% |
| Citric Acid | .2% |
| Potassium Sorbate | .1% |
| Sorbic Acid | .1% |
| Agar | .05% |

We claim:

1. A glaze comprising a sugar system comprising a first non-crystalline, fully saturated phase, a second water-based phase, and a third crystalline phase, wherein:
the first non-crystalline, fully saturated phase comprises: one primary sugar chosen from: isomaltulose and trehalose; water; and at least one hydrocolloid gum;
the second water-based phase comprises: at least one ingredient chosen from: cocoa; a hydrocolloid gum; and a food grade fiber; and a food grade starch; and
the third crystalline phase comprises: one primary sugar chosen from isomaltulose and trehalose suspended in the mixture of the first non-crystalline phase and the second water-based phase.

2. The glaze as claimed in claim 1, wherein the at least one hydrocolloid gum in both the first non-crystalline phase and the second water-based phase is chosen from: guar gum; xanthan gum; gellan; carboxymethyl cellulose (CMC), pectin; gelatin; Alginate; Carrageenan; Cassia; Fenugreek; Gum Arabic; Gum Ghatti; Gum Karaya; Konjac; locust; bean gum; and tara.

3. The glaze as claimed in claim 1, wherein the at least one food grade fiber in the second water-based phase is chosen from: potato; banana; wheat; corn; sugar cane; sugar pea; lentil; chia; pear; apple; orange; almond; broccoli; peanut; rice; cellulose.

4. The glaze as claimed in claim 1, wherein the at least one food grade starch is chosen from: corn, wheat, tapioca, potato, and banana.

5. The glaze as claimed in claim 1, wherein the first non-crystalline, fully saturated phase further comprises about at least one ingredient chosen from: a flavoring; a salt; a fat; an artificial sweetener; a preservative; an emulsifier; a pH modifier; a coloring; and a preservative.

6. The glaze as claimed in claim 5, wherein the first non-crystalline, fully saturated phase further comprises at least one secondary sugar chosen from: isomaltulose; trehalose; sucrose; dextrose; fructose; glucose; and allulose.

7. The glaze as claimed in claim 1, wherein the third crystalline phase further comprises at least one secondary sugar chosen from: isomaltulose; trehalose; sucrose; dextrose; fructose; glucose; and allulose.

8. The glaze as claimed in claim 6, wherein the at least one secondary sugar is: sucrose.

9. The glaze as claimed in claim 1, wherein the ratio of the first non-crystalline, fully saturated phase and the second water-based phase to the third crystalline phase is 1.3:1 to 2:1.

10. A method for making a glaze to coat a baked good comprising the steps of:
a. mixing a combination of: about 20-55% water; about 20-60% of one primary sugar chosen from: isomaltulose and trehalose; at least one ingredient chosen from: about 3-30% cocoa; about 0.2-5% of at least one hydrocolloid gum; about 0.5-5% of at least one food grade fiber; and about 0.5-10% of at least one food grade starch;
b. heating the mixture from step a to about 170° F.-218° F. for about 0.5 seconds-3 minutes;
c. adding the hot syrup from step b. into about 35-65% of one primary sugar chosen from: isomaltulose and trehalose;
d. holding the glaze made in step c. at from about 115-160° F.; and
e. applying the glaze from step d. to the baked good at from about 115-160° F.

11. The method as claimed in claim 10, wherein the hydrocolloid gum from step a. is chosen from: agar; guar gum; xanthan gum; glean; gellan; carboxymethyl cellulose (CMC), pectin; gelatin; Alginate; Carrageenan; Cassia; Fenugreek; Gum Arabic; Gum Ghatti; Gum Karaya; Konjac; locust; bean gum; and tara.

12. The method as claimed in claim 10, wherein the at least one food grade fiber in the second water-based phase is chosen from: potato; banana; wheat; corn; sugar cane; sugar pea; lentil; chia; pear; apple; orange; almond; broccoli; peanut; rice; cellulose; and the at least one food starch in the second phase is chosen from: corn; wheat; tapioca; potato; and banana.

13. The method as claimed in claim 10, wherein the at least one food grade starch is chosen from: corn, wheat, tapioca, potato, and banana.

14. The method as claimed in claim 10, in which step c. further comprises up to 40% of at least one secondary sugar chosen from: isomaltulose; trehalose; sucrose; dextrose; fructose; glucose; and allulose.

15. The method as claimed in claim 14, wherein the at least one secondary sugar is sucrose.

16. The method as claimed in claim 10, wherein the baked good is chosen from: a donut; a cake; a pastry; a danish; and a cinnamon roll.

17. The glaze made by the method as claimed in claim 10, wherein the glaze comprises: about 20-60% of one primary sugar chosen from: isomaltulose and trehalose; about 20-55% water; and at least one ingredient chosen from: about 3-30% cocoa; about 0.2-10% of at least one hydrocolloid gum; and about 0.5-5% of at least one food grade fiber; and about 0.5-10% of at least one food grade starch.

18. The glaze as claimed in claim 17, which further comprises about 0.01-5% of at least one ingredient chosen from: a flavoring; a salt; a fat; an artificial sweetener; a preservative; an emulsifier; a pH modifier, a coloring; and a preservative.

19. The glaze as claimed in claim 17, which further comprises up to 40% at least one secondary sugar chosen from: isomaltulose; trehalose; sucrose; dextrose; fructose; glucose; and allulose.

20. The glaze as claimed in claim 19, wherein the at least one secondary sugar is sucrose.
